(19) United States
(12) Patent Application Publication
(10) Pub. No.: US 2010/0223715 A1
(43) Pub. Date: Sep. 9, 2010

(54) Gamma Resistant Nonwoven Web Laminate

(76) Inventor: Brian W. Lyons, Heath, TX (US)

Correspondence Address: The Marbury Law Group, PLLC, 11800 SUNRISE VALLEY DRIVE, SUITE 1000, RESTON, VA, 20191, US

(21) Appl. No.: 12/719,612

(22) Filed: Mar. 8, 2010

Related U.S. Application Data
(60) Provisional application No. 61/158,146, filed on Mar. 6, 2009.

(51) Int. Cl. A41D 13/00; B32B 5/18

(52) U.S. Cl. 2/455; 442/77

(57) ABSTRACT

A gamma and E-Beam resistant nonwoven web laminate material is provided for use in the industry. The nonwoven web laminate may include at least one layer of a nonwoven material and a second layer of a coating material. The coating material of the nonwoven web laminate material may include a microporous film with water vapor transmission rate of 7500 G/24 hours period.

This application claims priority under 35 U.S.C. §119(e) from provisional application No. 61/158,146 filed Mar. 6, 2009.

### FIELD OF THE INVENTION

Various embodiments relate to fabrics comprising a nonwoven material made from nonwoven materials and adhesively bonded to films and irradiated by Gamma or E-Beam sterilization to form new products and application for the gamma resistant nonwoven web laminates.

### BACKGROUND OF THE INVENTION

Nonwoven materials and their laminates may be used in a variety of applications. They may be used in healthcare as medical protective garments, surgical drapes, clean room garments, and in burn units. They may be used in the industry in decontamination units, personal protective garments, drapes and to keep certain environments, such as surgical fields, sterilized.

In certain applications, such as in drapes used in surgery, the nonwoven materials may require sterilization. Several sterilization techniques may be used in the industry. Sterilization techniques which employ Gamma rays or electron beams (E-Beam) are preferred. Gamma rays and E-Beams are preferred because they may be used to kill organisms, such as bacteria. This process of killing organisms is called irradiation. Gamma rays have very short wavelengths and a single incident photon can cause significant damage to living cells. E-Beams use electrons, usually high energy electrons, which can also cause damage to living cells and may be used to sterilize objects.

Because gamma rays and E-Beams are very strong, they may cause damage to nonwoven materials as well as causing the materials to lose certain physical and functional properties and become malodorous. Therefore, more research is required in the industry, to produce fabrics constructed with components that are not significantly affected by Gamma or E-Beam irradiation.

### SUMMARY OF THE INVENTION

Embodiments comprise a nonwoven web laminate including gamma and E-Beam sterilizable nonwoven and coating materials. The coating material may include a microporous film with water vapor transmission rate of 7500 G/24 hours period. Embodiments of the nonwoven web laminate do not degrade or become malodorous when it is subjected to gamma radiation of over 60 kGy. The gamma and E-Beam resistant nonwoven web laminates may be used to construct gamma and E-Beam resistant composite fabrics.

### DETAILED DESCRIPTION

The term “fiber” or “fibrous” means a particulate material in which the length and diameter ratio of each material is greater than about 10. Conversely, “non-fiber” or “non-fibrous” means a particulate material in which the linked diameter ratio is about 10 or less.

The term “polyester” as used herein is intended to embrace polymers wherein at least 85% of the recurring units are condensation products of dicarboxylic acid and dihydroxy alcohols with linkage created by formation of ester units. This includes aromatic, aliphatic, saturated, and unsaturated di-acids and di-alcohols. The term “polyester” as used herein also includes copolymers (such as block, graft, random and alternating copolymers), blends, and modifications thereof. A common example of polyester is polyethylene terephthalate (PET) which is condensation products of ethylene glycol and terephthalic acid.

The term “nylon” as used herein is intended to include condensation copolymers formed by reacting equal parts of diamine and dicarboxylic acid, so that peptide bonds form at both ends of each monomer in a process analogous to polypeptide biopolymers. As with other regular copolymers, such as polyesters, the recurring unit consists of one of each monomer, so that they alternate in the chain.

The term “spunbond” filaments as used herein means the filaments which are formed by extruding molten thermoplastic polymer material as filaments from a plurality of fine capillaries of a spinneret with a diameter of the extruded filaments and then being rapidly reduced by drawing. Spunbond filaments are generally continuous and usually have an average diameter of greater than about five microns. Spunbond nonwoven fabrics or webs are formed by laying spunbond filaments randomly on the collecting surface such as a foraminous screen or belt. Spunbond webs can be bonded by methods known in the art such as hot-role calendaring, through air bonding, or bypassing the web through its saturated-steam chamber at an elevated pressure. For example, the web can be thermally point bonded at a plurality of thermal bond points located across the spunbond fabric.

The term “meltblown” fibers as used herein refer to fibers which are formed by extruding a melt-processable polymer through a plurality of capillaries as molten threads or filaments into a high velocity heated gas stream. A high velocity gas stream attenuates the filaments are molten thermoplastic polymer material to reduce their diameter to between about 0.5 and 10 microns. The meltblown fibers are generally discontinuous fibers but can also be continuous. The meltblown fibers carried by the high velocity gas stream are generally deposited on the collecting surface to form a meltblown web of randomly dispersed fibers.

The term “cardable” fibers as used herein means a fiber that can be brushed or washed to prepare them as textiles. Carding is used to take unordered fibers and prepare them for spinning to produce webs of fibre to go into nonwoven products depending on the mechanism at the output from the card. It can also be used to create blends of different fibers or different colors. The process of carding mixes up the different fibers, thus creating a homogeneous mix of the various types of fibers, at the same time as it orders them and gets rid of the tangles.

The term “cardable thermal bonded” fibers as used herein means mechanical process involving thousands of needles that orient and interlock fibers to create a nonwoven fabric.

The term “needle punched bonded” fibers as used herein means a mechanical process involving thousands of needles that orient and interlock fibers to create non-woven fabric.

The term “needle punched reinforced scrim” material as used herein means a scrim that is created with the needle punch bonding process.

The term “hydroentangled” fibers as used herein refer to any fiber or filament that is produced using hydroentangling methods. Hydroentangling methods includes the process of subjecting a card web to high pressure fluid jet stream in order to entangle fibers in web and thereby providing specific entangled structure and suitable mechanical properties to the web. The nonwoven fabrics produced by this hydroentangling process permits higher mobility of fibers within the fabrics than any other textile fabrics and nonwoven fabrics because the fibers are simply mechanically entangled and not firmly bonded together. Therefore, the fibers have soft and link free properties which together would improve drape and soft touch properties.

Certain of the fabrics illustrated herein are bonded with viscose hydroentangled fibers.

The term “nonwoven fabric, sheet or web” as used herein means a structure of individual fibers, filaments, or threads that are positioned in a random manner to form a planar material without an identifiable pattern, as opposed to a knitted or woven fabric.

The term “filament” is used herein to refer to continuous filaments whereas the term “fiber” is used herein to refer to either continuous or discontinuous fibers.

The term “multiple component of filament” and “multiple component fiber” as used herein referred to any filaments or fiber that is composed of at least two distinct polymers which have been spun together to form a single filament or fiber. Multiple component fibers or filaments may be bicomponent fibers or filaments which are made from two distinct polymers and arranged in distinct zones across the cross-section of the multiple component fibers and extending along the length of the fibers. Multiple component fibers and filaments may include sheet-core and side-by-side fibers.

As used herein, “biconstituent fiber” or “multiconstituent fiber” means the fiber comprising an intimate blend of at least two polymer constituents combined before the extrusion process.

The term “multiconstituent web” as used herein refers to a nonwoven web comprising multiconstituent fibers or multiconstituent filaments. The term “biconstituent web” as used herein refers to a non-woven web comprising biconstituent filaments or biconstituent fibers. The multiconstituent and biconstituent weds may be comprised of blends of multiple constituent fibers with single constituent fibers.

The term “linear low density polyethylene” (LLDPE) as used herein refers to the linear ethylene/α-olefin copolymers having a density of less than about 0.955 g/cm3. Linear near low density polyethylene is used in the various embodiments are prepared by copolymerizing ethylene would minor amounts alpha, beta-ethylenically unsaturated alkene copolymer (α-olefin), the α-olefin call monomer having from 3 to 12 carbons per α-olefin molecule Alpha-olefins which can be copolymerized with ethylene to produce LLDPE's useful in the various embodiments may include propylene, 1-butene, 1-pentene, 1-hexene, 1-octene, 1-decene, or a mixture thereof. Such polymers are turned “linear” because of the substantial absence of branched chains of polymerized monomer units pendant from the main polymer “backbone.” Linear low-density polyethylene used in the various embodiments may be prepared using either Ziegler Natta or metalocene catalysts. Examples of suitable commercially available LLDPE's include those available from the Dow Chemical Company, such as ASPUN Type 6811A (density 0.923 g/cm3), Dow LLDPE 2500 (density 0.923 g/cm3), Dow LLDPE Type 6808A (density 0.940 g/cm3), ENGAGE® (Dow Chemical Co.) and the EXACT® and EXCEED™ series of LLDPE polymers from Exxon Chemical Company, such as EXACT® 2003 (density 0.921 g/cm3).

The term “high density polyethylene” (HDPE) as used herein refers to polyethylene home all polymer having a density of at least about 0.94 g/cm3, and preferably in the range of about 0.94 g/cm3 to about 0.965 g/cm3.

The term “lamination” as used herein means combining two materials to result in the modification of physical properties based on the individual characteristics of the separate components. Lamination of any fabric produces a “laminate.”

The various embodiments provide nonwoven web laminates that are Gamma ray or E-Beam resistant and include improved particle barrier properties for particles in the size range of between 0.04 microns and 0.3 microns. The nonwoven web laminates of the various embodiments may include at least two layers. A first layer may include nonwoven materials, such as polyester spunbond web, and a second layer may include coating materials, such as a polyethylene barrier film.

In one embodiment, the nonwoven material may entirely or partially comprise of polyester or polyamide (nylon) fibers. For example, the nonwoven material may comprise entirely of polyester fibers. Nonwoven polyester fibers may include 100% polyester spunbond fibers, 100% polyester carded thermal bonded fibers, 100% polyester needle punched bonded fibers, 100% polyester needle punched reinforced scrim material, 100% polyester hydroentangled fibers, 100% polyester blended with nylon hydroentangled fibers. The 100% polyester needle punched reinforced scrim may use material such as cotton, polyester, polyethylene or nylon bonded fibers.

Nonwoven nylon fibers may include 100% nylon spunbond fibers, 100% nylon carded thermal bonded fibers, 100% nylon needle punched bonded fibers, 100% nylon needle punched reinforced scrim material, 100% nylon hydroentangled fibers, 100% nylon bonded with viscose hydroentangled fibers. The 100% polyester needle punched reinforced scrim may use material such as cotton, polyester, polyethylene or nylon bonded fibers.

An embodiment of the nonwoven material may partially comprise from 100% polyester or 100% nylon and further comprise multiconstituent fibers or other cardable staple fibers. Multiconstituent fibers are used rather than multicomponent fibers (e.g. sheath-core or side-by-side bicomponent fibers) because multiconstituent fibers are significantly less expensive to manufacture. The manufacturing process for making multiconstituent fibers is less complex than the process used for making multicomponent fibers and the throughput rate during manufacturing of the fibers is much higher. Cardable staple fibers that are gamma or E-Beam resistant but are not multiconstituent fibers include, for example, cellulosic fibers such as cotton or rayon fibers.

In an embodiment, the nonwoven material may partially comprise multiconstituent fibers or other cardable staple fibers as long as at least 75% by weight of the nonwoven material comprises of a gamma or E-Beam resistant polymer. In another embodiment, the nonwoven material may be partially made from multiconstituent fibers or other cardable staple fibers as long as 100% by weight of the nonwoven material comprises of a gamma or E-Beam resistant polymer.

Gamma or E-Beam resistant polymers useful in preparing the multiconstituent nonwoven fibers of the various embodiments may include polyethylene, polyester, and polystyrene. In many applications, polyethylene may be the preferred compound. The ethylene polymer may be a copolymer or an ethylene homopolymer or copolymer. An ethylene homopolymer may be a low density, high density, or linear low density ethylene polymer. An ethylene copolymer may include up to 20% by weight of another α-olefin such as propylene, butane, octane and hexane. The ethylene 10 polymer fibers typically have a density of about 0.88 to about 0.97 g/cm3.

The multiconstituent fibers used to make the nonwoven materials of the various embodiments may include fibers spun from a polymer melt that is a blend of polymers. The multiconstituent fibers may have hydrophobic or hydrophilic surface, or a mixture of fibers having hydrophobic and hydrophilic surfaces. Cardable multiconstituent staple fibers may include, for example, T-412 and T-413 HIMED.™. Polyolefin fibers available from Hercules Inc., Wilmington, Del., U.S.

In the various embodiments, cardable multiconstituent fibers may have a fiber fineness greater than 1.5 decitex. However, fibers having a fineness less than 1.5 decitex can also be used. Decitex is the weight in grams of 10,000 meters of each fiber. The staple fibers are preferably about 1 to about 6 inches long, or more preferably about 1 to about 3 inches, and most preferably about 1¼ to about 2 inches long.

The multiconstituent fibers may include two types of ethylene polymers. One ethylene polymer may be, for example, high density polyethylene. Another ethylene polymer may be, for example, linear low density polyethylene.

High density polyethylenes spin well in conventional spunbond processes and produce very low levels of volatile materials during spinning. However, these polyethylenes yield very stiff filaments, making it difficult to lay the filaments down uniformly on a collecting surface during certain preparations, such as the spunbond process, and provide materials having a hard hand. Additionally, the bonding window for these polyethylenes is very narrow, making it difficult to process. The term “bonding window” means the range of temperatures over which bonding is successful. The bonding window for high density polyethylenes is from about 125° C. to 133° C. Below 125° C. the high density polyethylene is not hot enough to melt and bond. Above 133° C., it will melt excessively.

Linear low density polyethylenes are easier to process because they have a wider bonding window. The bonding window for linear low density polyethylenes is between about 100° C. and 125° C. The linear low density polyethylenes also form materials having the desirable soft hand. However, it may be difficult to process linear low density polyethylenes because of the high levels of volatile materials that they emit during, for example, spunbond extrusion process. The high levels of deposit formation on the processing equipment dictate that the manufacturing process shut-down every so often to clean the equipment. As a result, this process is more time consuming and more costly as compared to the high density polyethylenes processing.

In an embodiment, the multiconstituent fibers may include a dominant continuous linear low density polyethylene phase and at least one discontinuous phase including high density polyethylene The discontinuous phase may be dispersed through the dominant continuous phase in the form of domains, at least about 70% by weight of the discontinuous phase comprising domains having a diameter between about 0.05 and about 0.03 micron. The linear low density polyethylene preferably comprises about 55% to about 90% by weight of the fiber. More preferably, the linear low density polyethylene comprises about 70% to about 90% by weight of the fiber. Most preferably, the linear low density polyethylene comprises about 80% to about 90% by weight of the fiber. These fibers, their preparations and nonwoven materials made from these fibers are disclosed in U.S. Pat. No. 5,487,943.

In the various embodiments, the coating material used in the second layer of the fabric of this invention may be a gamma radiation or E-Beam resistant polymer. Gamma radiation or E-Beam resistant polymers may include polyethylene, polystyrene, polyester, and cellulosic fibers such as cotton, rayon, and wood pulp fibers. Preferably the coating material used in the second layer of the nonwoven web laminate is polyethylene. The ethylene polymer can be an ethylene homopolymer or a copolymer of ethylene and up to 20% by weight of another α-olafine such as, for example, propylene, butane, octane, and hexene. The ethylene homopolymer can be a low density, high density, or linear low-density ethylene polymer. Preferable, the coating layer may be a film.

In the various embodiments, the coating layer may be a barrier layer. When film is used as a barrier later, it may be a microporous film. In a preferred embodiment, a microporous film layer may possess a water vapor transmission rate (WVTR) of 7500 G/24 hours period or greater.

In an embodiment, calcium carbonate may be added in the production process of microporous films. Varying the amounts of calcium carbonate in the process of making the films of the various embodiments may affect the microporous properties of the films. The microporous film layer with a WVTR of 7500 G/24 hour period may be created by adding an effective amount of calcium carbonate to the film material during production. The process of creating microporous films is routine in this field.

Microporous films used in the various embodiments are liquid-impermeable, and may or may not be permeable to air. Permeability to air may depend on the type of material used in the coating layer. In a preferred embodiment, the microporous film used in the laminate is permeable to air while impermeable to liquids.

The material used in the coating layer of the various embodiment fabrics may be air impermeable.

At least one nonwoven material and at least one coating layer are combined to form the nonwoven web laminate used in the various embodiments. The techniques used to bond the layers of this nonwoven web laminate may include continuous hot melt steam, bonding thermal calendar bonding, ultrasonic bonding, and spot adhesive bonding.

The components of the fabric are preferably bonded. The nonwoven material can also be thermally consolidated before it is combined with the barrier layer using any one of a combination of techniques such as calendar thermal bonding, through air-bonding, high drilling tangling, needle punching, ultrasonic bonding and latex bonding. When the barrier layer is a film, a separate layer of film can be combined with the nonwoven material, or thin layers of film can be extrusion-coated onto the nonwoven material. Additional layers, such as a spunbonded layer may also be present as long as they are gamma or E-Beam resistant.

According to an embodiment, either the nonwoven fabric or the barrier layer or both can contain additives commonly used in the art such as pigments, fillers, stabilizers, and antioxidants.

In a further embodiment, the nonwoven web laminate has a particulate filtration efficiency percent improvement, for particles having a size range from 0.04 microns to 0.3 microns.

For certain nonwoven web laminate end uses, it is desirable that the nonwoven fabrics have good heat sealing properties when thermally bonded to an identical nonwoven fabric layer or to a dissimilar layer such as a nonwoven fabric comprising fibers of the different polymer composition. For example, in protecting apparel uses such as medical garments, it may be desirable to prepare the garments by heat sealing the seams to avoid formation of holes that occur when needles are inserted during the stitching process. Alternatively, reinforcing pieces may be thermally bonded in place instead of using an adhesive or stitching process.

In addition to good heat sealing properties, it is desirable that the nonwoven fabrics have high strength while also being as soft and drapable as possible. For medical end uses, it is also desirable that the nonwoven fabrics be made of fibers of polymers that can be sterilized by gamma radiation.

The nonwoven web laminate fabrics of the various embodiments are useful for any medical, hygienic, or related applications that would undergo gamma sterilization. For example the fabric of this invention may be used in surgical gallons, surgical drapes, and clean room garments. These fabrics are gamma radiation and E-Beam resistant and can endure gamma radiation treatment which is sufficient to sterilize the fabrics without exhibiting the physical or chemical property changes that may render the fabric unsuitable for their intended use.

The gamma radiation exposure levels use in the sterilization process or measure in Mrad (mega-rad) or kGy (kilo-Gray). One Mrad equals 10 kGy. The typical dosage for a sterilization processes is 2 to 6 Mrads (20-60 kGy). An embodiment nonwoven web laminate may not degrade or become malodorous when it is subjected to gamma radiation of over 60 kGy which can accomplish a 10⁻⁶ in Colony Forming Units.

The fabric basis weight is the weight in grams of one square meter of fabric. In an embodiment, the average basis weight of the nonwoven web laminate of the various embodiments may be between 1 oz and 10 oz per square yard.

An embodiment comprises nonwoven adhesively bonded web laminates having improved gamma or E-Beam resistance to physical degradation, malfunction and odor production while maintaining particulate barrier properties. These nonwoven adhesive bonded web laminates may also have improved particulate barrier properties for particles in the size range of between 0.04 microns and 0.3 microns.

According to the various embodiments, the nonwoven web laminate fabrics may be used in composite fabrics for a variety of applications such as medical protective garments, surgical drapes, clean room garments, and burn units; decontamination units, personnel protective garments, drapes and sterile environments. The composite fabrics used in medical, decontamination and surgical applications often require sterilization prior to their use. The composite fabrics of this embodiment may be sterilized using gamma and E-Beam radiation without damage to the fabric or production of malodorous fumes. Several sterilization techniques, including gamma radiation and E-Beam irradiation, are used in the industry. Gamma radiation sterilization is the preferred technique although this is not meant as a limitation. During exposure to gamma or E-Beam radiation, significant degradation of fabric components will not occur and will not cause the loss of mechanical properties. Therefore, it is desirable that these fabrics are constructed of components that are not significantly affected by the gamma radiation levels used in commercial sterilization processes.

In an exemplary embodiment, a nonwoven web laminate fabric including microporous polyethylene film and polyester spunbond nonwoven may be used in composite fabrics. These composite fabrics typically comprise at least one fibrous layer to provide textile-like feel and comfort.

In a further exemplary embodiment, nonwoven web laminate fabric including polyethylene films and polyester spunbond nonwoven fabric may be used in composite fabrics. These composite fabrics typically comprise at least one fibrous layer to provide textile-like feel and comfort.

Polyesters, nylons and polyethylenes generally do not undergo extensive deterioration upon exposure to the dosages of gamma or E-Beam radiation used in sterilizing medical items. Polyester and nylon fabrics have other favorable attributes, including soft hand, good drape, and heat seal ability to polyethylene films. Polyethylene possesses a relative chemical inertness in comparison with polyester or nylon fabrics, especially its resistance to acidic or alkaline conditions.

In a further exemplary embodiment, nonwoven web laminate fabric including microporous polyethylene film and polyester carded thermal bond nonwoven material may be used in composite fabrics. The composite fabric of this embodiment comprises at least one fibrous layer to provide textile-like feel and comfort.

In a further exemplary embodiment, nonwoven web laminate fabric including polyethylene film and polyester carded thermal bond nonwoven material may be used in composite fabrics. These composite fabrics typically comprise at least one fibrous layer to provide textile-like feel and comfort.

In a further exemplary embodiment, nonwoven web laminate fabric that may be used in a composite fabric may include a multilayer nonwoven web laminate of at least two layers formed from one layer of polyester needle punched bonded fibers and at least one layer formed from polyethylene microporous film wherein the layer formed from the polyethylene microporous film acts as the barrier and the polyester needle punched bonded fibers acts as the carrier sheet. The microporous film may have a water vapor transmission rate of 7500 G/24 hr period or greater. These composite fabrics typically comprise at least one fibrous layer to provide textile-like feel and comfort. The composite material of this exemplary embodiment may be used in the form of erectable tents for decontamination or in sterile blankets for patients. Other applications may include personal protective apparel as well as surgical drapes.

In a further exemplary embodiment, nonwoven web laminate fabric that may be used in a composite fabric may include a multilayer nonwoven web laminate comprising at least two layers formed from one layer of polyester needle punched bonded fibers and at least one layer formed from polyethylene film wherein the layer formed from polyethylene film acts as the barrier and the polyester needle punched bonded fibers acts as the carrier sheet. These composite fabrics typically comprise at least one fibrous layer to provide textile-like feel and comfort. The composite material of this exemplary embodiment may be used in the form of erectable tents for decontamination or in sterile blankets for patients. Other applications may include personal protective apparel as well as surgical drapes.

In a further embodiment, nonwoven web laminate fabric that may be used in a composite fabric may include a multilayer nonwoven web laminate comprising at least two layers formed from one layer of polyester needle punched reinforced scrim material, the scrim material being cotton, polyester, polyethylene or nylon bonded fibers and at least one layer formed from polyethylene microporous film wherein the layer formed from microporous film acts as the barrier and the polyester needle punched reinforced scrim material acts as the carrier sheet. The microporous film may have a water vapor transmission rate of 7500 G/24 hr period or greater. The composite material of this exemplary embodiment may be used in the form of erectable tents for decontamination or in sterile blankets for patients. Other applications may include personal protective apparel as well as surgical drapes.

In a further exemplary embodiment, nonwoven web laminate fabric that may be used in a composite fabric may include a multilayer nonwoven web laminate comprising at least two layers formed from one layer of polyester needle punched reinforced scrim material, the scrim material being cotton, polyester, polyethylene or nylon bonded fibers and at least one layer formed from polyethylene film wherein the layer formed from microporous film acts as the barrier and the polyester needle punched reinforced scrim material acts as the carrier sheet. The composite material of this exemplary embodiment may be used in the form of erectable tents for decontamination or in sterile blankets for patients. Other applications may include personal protective apparel as well as surgical drapes.

In a further embodiment, nonwoven web laminate fabric that may be used in a composite fabric may include a microporous polyethylene film and polyester spunlace nonwoven material may be used in a variety of applications such as medical protective garments, surgical drapes, clean room garments, burn units, decontamination units, personnel protective garments, drapes and sterile environments.

In a further exemplary embodiment, nonwoven web laminate fabric that may be used in a composite fabric may include a multilayer nonwoven web laminate comprising at least two layers formed from one layer of polyester blended with rayon hydro entangled fibers and at least one layer formed from polyethylene film wherein the layer formed from polyethylene film acts as the barrier and the polyester blended with viscose hydro entangled fiber material acts as the carrier sheet. The composite material of this exemplary embodiment may be used in the form of erectable tents for decontamination or in sterile blankets for patients. Other applications may include personal protective apparel as well as surgical drapes.

In a further exemplary embodiment, nonwoven web laminate fabric that may be used in a composite fabric may include a microporous polyethylene film and nylon spunbond nonwoven material. This composite fabric may be used in a variety of applications such as medical protective garments, surgical drapes, clean room garments, and burn units; decontamination units, personnel protective garments, drapes and sterile environments.

In a further exemplary embodiment, nonwoven web laminate fabric that may be used in a composite fabric may include a polyethylene film and nylon spunbond nonwoven material. These composite fabrics may be used in a variety of applications such as medical protective garments, surgical drapes, clean room garments, and burn units; decontamination units, personnel protective garments, drapes and sterile environments.

In a further exemplary embodiment, nonwoven web laminate fabric that may be used in a composite fabric may include a microporous polyethylene film and nylon carded thermal bond nonwovens. The fabrics of this embodiment may be used in a variety of applications such as medical protective garments, surgical drapes, clean room garments, burn units, decontamination units, personnel protective garments, drapes, and sterile environments.

In a further exemplary embodiment, nonwoven web laminate fabric that may be used in a composite fabric may include a polyethylene film and nylon carded thermal bond nonwovens. The composite fabrics of this embodiment may be used in a variety of applications such as medical protective garments, surgical drapes, clean room garments, burn units, decontamination units, personnel protective garments, drapes and sterile environments. These composite fabrics may typically comprise at least one fibrous layer to provide textile-like feel and comfort.

In a further exemplary embodiment, nonwoven web laminate fabric that may be used in a composite fabric may include a multilayer nonwoven web laminate comprising at least two layers formed from one layer of nylon needle punched bonded fibers and at least one layer formed from polyethylene microporous film wherein the layer formed from microporous film acts as the barrier and the nylon needle punched bonded fibers acts as the carrier sheet. The microporous film may have a water vapor transmission rate of 7500 G/24 hr period or greater. The composite material of this exemplary embodiment may be used in the form of erectable tents for decontamination or in sterile blankets for the patient. Other applications may include personal protective apparel as well as surgical drapes.

In a further exemplary embodiment, nonwoven web laminate fabric that may be used in a composite fabric may include a multilayer nonwoven web laminate comprising at least two layers formed from one layer of nylon needle punched bonded fibers and at least one layer formed from polyethylene film wherein the layer formed from film acts as the barrier and the nylon needle punched bonded fibers acts as the carrier sheet. The composite material of this exemplary embodiment may be used in the form of erectable tents for decontamination or in sterile blankets for the patient. Other applications may include personal protective apparel as well as surgical drapes.

In a further exemplary embodiment, nonwoven web laminate fabric that may be used in a composite fabric may include a multilayer nonwoven web laminate comprising at least two layers formed from one layer of nylon needle punched reinforced scrim material, the scrim material being cotton, nylon, polyethylene or nylon bonded fibers and at least one layer formed from polyethylene microporous film wherein the layer formed from microporous film acts as the barrier and the nylon needle punched reinforced scrim material acts as the carrier sheet. The microporous film may have a water vapor transmission rate of 7500 G/24 hr period or greater. The composite material of this exemplary embodiment may be used in the form of erectable tents for decontamination or in sterile blankets for the patient. Other applications may include personal protective apparel as well as surgical drapes.

In a further exemplary embodiment, nonwoven web laminate fabric that may be used in a composite fabric may include a multilayer nonwoven web laminate comprising at least two layers formed from one layer of nylon needle punched reinforced scrim material, the scrim material being cotton, nylon, polyethylene or nylon bonded fibers and at least one layer formed from polyethylene film wherein the layer formed from film acts as the barrier and the nylon needle punched reinforced scrim material acts as the carrier sheet. The composite material of this exemplary embodiment may be used in the form of erectable tents for decontamination or in sterile blankets for the patient. Other applications may include personal protective apparel as well as surgical drapes.

In a further exemplary embodiment, nonwoven web laminate fabric that may be used in a composite fabric may include a microporous polyethylene film and nylon spunlace nonwoven material. The composite material of this exemplary embodiment may be used in a variety of applications such as medical protective garments, surgical drapes, clean room garments, burn units, decontamination units, personnel protective garments, drapes and sterile environments.

In a further exemplary embodiment, nonwoven web laminate fabric that may be used in a composite fabric may include an polyethylene film and nylon spunlace nonwoven material. The composite material of this exemplary embodiment may be used in a variety of applications such as erectable tents for decontamination or in sterile blankets for the patient. Other applications may include personal protective apparel as well as surgical drapes.

In a further exemplary embodiment, nonwoven web laminate fabric that may be used in a composite fabric may include a microporous polyethylene film and nylon blended with rayon spunlace nonwoven. The composite material of this exemplary embodiment may be used in a variety of applications such as medical protective garments, surgical drapes, clean room garments, burn units, decontamination units, personnel protective garments, drapes and sterile environments.

In a further exemplary embodiment, nonwoven web laminate fabric that may be used in a composite fabric may include a polyethylene film and nylon blended with rayon spunlace nonwoven material. The composite material of this exemplary embodiment may be used in a variety of applications such as erectable tents for decontamination or in sterile blankets for the patient. Other applications may include personal protective apparel as well as surgical drapes.

Other layers may also be present having gamma-sterilizable characteristics. The barrier fabrics of the various embodiments illustrated above are drape able and have a textile-like feel. They substantially retain their mechanical properties after exposure to gamma radiation levels typically used in commercial sterilization processes whether Gamma or E-Beam sterilization.

An embodiment comprises about 30 grams per square meter (GSM) polyethylene microporous laminate, about 30 GSM polyester non woven fabric or web and about 3.5 GSM of adhesive for adhesively bonding the layers one to another. These weights are not meant as limitations.

An alternate embodiment comprises a 25 GSM polyethylene microporous laminate, a 25 GSM polyester non woven fabric and 3.5 GSM adhesive for adhesively bonding the layers one to another. These weights are not meant as limitations.

In still another embodiment, the GSM polyethylene microporous laminate, and polyester non woven fabric or web are bonding together using thermal means known in the art.

Fabrics of the type described in various embodiments here will find use in a variety of markets such as, but without limitation, Clean rooms, Pharmaceutical manufacturing, Aerospace applications, Healthcare, Operating rooms, Hospitals, Medical device manufacturing, Animal research and Biological research application.

In a further embodiment, the fabrics of the various embodiments may be used to make garments which are in the form of coveralls with and without hoods and booties, aprons, lab coats, shoe and booty covers, and clean-room garments. The fabrics of the various embodiments may be used in the construction of protective garments that include a body portion having a neck opening in the shoulder line at its top, two sleeves portions extending from the body portion, each sleeve portion having an inner edge and an outer edge, and two leg portions extending from the body portion.

The garments of various embodiments may include a mask for covering the mouth and nose of a user and constructed from the same material as the body of the garment. The mask for covering the mouth and nose may be an extension of the fabric of the body at the neck opening. The mask may also be a removable mask. A user of the garment may be able to pull and secure the mask over his mouth and nose to protect him from inhaling particles in the air.

It will also be understood that the invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. A nonwoven web laminate comprising:
a gamma sterilizable nonwoven material; and
a gamma sterilizable coating material,
wherein the coating material is a microporous film with water vapor transmission rate of 7500 G/24 hours period, and
wherein the nonwoven web laminate may not degrade or become malodorous when it is subjected to gamma radiation of over 60 kGy.

2. The nonwoven web laminate of claim 1, wherein the average basis weight of the nonwoven web laminate is between about 1 ounce and about 10 ounces per square yard.

3. The nonwoven web laminate of claim 1, wherein the nonwoven web laminate includes improved particle barrier properties for particles in the size range of between about 0.04 microns to about 0.3 microns.

4. The nonwoven web laminate of claim 1, wherein the nonwoven material is comprised entirely from polyester fibers.

5. The nonwoven web laminate of claim 4, wherein the polyester fibers are selected from a group consisting of 100% polyester spunbond fibers, 100% polyester carded thermal bonded fibers, 100% polyester needle punched bonded fibers, 100% polyester needle punched reinforced scrim material, 100% polyester hydroentangled fibers, 100% polyester blended with nylon hydroentangled fibers.

6. The nonwoven web laminate of claim 1, wherein the nonwoven material comprises multiconstituent fibers.

7. The nonwoven web laminate of claim 6, wherein the nonwoven material comprises from at least 75% by weight of a gamma resistant polymer.

8. The nonwoven web laminate of claim 6, wherein the multiconstituent fibers include ethylene polymers selected from a group consisting of high density polyethylene and linear low density polyethylene.

9. The nonwoven web laminate of claim 8, wherein the multiconstituent fibers include a dominant continuous linear low density polyethylene phase and at least one discontinuous high density polyethylene phase.

10. The nonwoven web laminate of claim 1, wherein the coating material is a polyethylene barrier film.

11. The nonwoven web laminate of claim 1, wherein the coating material is polyethylene barrier film.

12. The nonwoven web laminate of claim 1, wherein the coating material is permeable to air.

13. The nonwoven web laminate of claim 1, wherein the nonwoven web laminate is used in a composite fabric.

14. The nonwoven web laminate of claim 13, wherein the composite fabric includes polyethylene films and polyester spunbond nonwoven fabric

15. The nonwoven web laminate of claim 13, wherein the composite fabric includes microporous polyethylene film and polyester carded thermal bond nonwoven material.

16. The nonwoven web laminate of claim 13, wherein the nonwoven web laminate includes a multilayer nonwoven web laminate of at least two layers formed from one layer of polyester needle punched bonded fibers and at least one layer formed from polyethylene microporous film wherein the layer formed from the polyethylene microporous film acts as a barrier and the polyester needle punched bonded fibers acts as a carrier sheet.

17. The nonwoven web laminate of claim 13, wherein the composite fabric includes a multilayer nonwoven web laminate comprising at least two layers formed from one layer of polyester needle punched reinforced scrim material, the scrim material being cotton, polyester, polyethylene or nylon bonded fibers and at least one layer formed from polyethylene microporous film wherein the layer formed from microporous film acts as a barrier and the polyester needle punched reinforced scrim material acts as a carrier sheet.

18. The nonwoven web laminate of claim 13, wherein the composite fabric includes a multilayer nonwoven web laminate comprising at least two layers formed from one layer of polyester needle punched bonded fibers and at least one layer formed from polyethylene film wherein the layer formed from the polyethylene film acts as the barrier and the polyester needle punched bonded fibers acts as the carrier sheet.

19. The nonwoven web laminate of claim 13, wherein the composite fabric includes a microporous polyethylene film and polyester spunlace nonwoven material.

20. The nonwoven web laminate of claim 13, wherein the composite fabric includes a multilayer nonwoven web laminate comprising at least two layers formed from one layer of polyester needle punched reinforced scrim material, the scrim material being cotton, polyester, polyethylene or nylon bonded fibers and at least one layer formed from polyethylene film wherein the layer formed from microporous film acts as the barrier and the polyester needle punched reinforced scrim material acts as the carrier sheet.

21. The nonwoven web laminate of claim 13, wherein the composite fabric includes a microporous polyethylene film and nylon spunbond nonwoven material.

20. The nonwoven web laminate of claim 13, wherein the composite fabric includes a microporous polyethylene film and nylon carded thermal bond nonwovens.

21. The nonwoven web laminate of claim 13, wherein the composite fabric includes a multilayer nonwoven web laminate comprising at least two layers formed from one layer of nylon needle punched bonded fibers and at least one layer formed from polyethylene microporous film wherein the layer formed from microporous film acts as a barrier and the nylon needle punched bonded fibers acts as a carrier sheet.

22. The nonwoven web laminate of claim 13, wherein the composite fabric includes a multilayer nonwoven web laminate comprising at least two layers formed from one layer of polyester blended with rayon hydro entangled fibers and at least one layer formed from polyethylene film wherein the layer formed from polyethylene film acts as the barrier and the polyester blended with viscose hydro entangled fiber material acts as the carrier sheet.

23. The nonwoven web laminate of claim 13, wherein the composite fabric includes a multilayer nonwoven web laminate comprising at least two layers formed from one layer of nylon needle punched reinforced scrim material, the scrim material being cotton, nylon, polyethylene or nylon bonded fibers and at least one layer formed from polyethylene microporous film wherein the layer formed from microporous film acts as a barrier and the nylon needle punched reinforced scrim material acts as a carrier sheet.

24. The nonwoven web laminate of claim 13, wherein the composite fabric includes a microporous polyethylene film and nylon spunlace nonwoven material.

25. The nonwoven web laminate of claim 13, wherein the composite fabric includes a polyethylene film and nylon spunbond nonwoven material.

26. The nonwoven web laminate of claim 13, wherein the composite fabric includes a microporous polyethylene film and nylon blended with rayon Spunlace nonwoven

27. The nonwoven web laminate of claim 13, wherein the composite fabric includes an polyethylene film and nylon blended with rayon spunlace nonwoven material.

28. The nonwoven web laminate of claim 13, wherein the composite fabric includes a polyethylene film and nylon carded thermal bond nonwovens.

29. The nonwoven web laminate of claim 13, wherein the composite fabric includes a multilayer nonwoven web laminate comprising at least two layers formed from one layer of nylon needle punched bonded fibers and at least one layer formed from polyethylene film wherein the layer formed from film acts as the barrier and the nylon needle punched bonded fibers acts as the carrier sheet.

30. The nonwoven web laminate of claim 13, wherein the composite fabric includes a multilayer nonwoven web laminate comprising at least two layers formed from one layer of nylon needle punched reinforced scrim material, the scrim material being cotton, nylon, polyethylene or nylon bonded fibers and at least one layer formed from polyethylene film wherein the layer formed from film acts as the barrier and the nylon needle punched reinforced scrim material acts as the carrier sheet.

32. The nonwoven web laminate of claim 13, wherein the composite fabric includes a polyethylene film and nylon spunlace nonwoven material.

33. A protective garment comprising:
a body made from a fabric comprising:
a gamma sterilizable nonwoven material; and
a gamma sterilizable coating material,
wherein the coating material is a microporous film with water vapor transmission rate of 7500 G/24 hours period, and
wherein the nonwoven web laminate may not degrade or become malodorous when it is subjected to gamma radiation of over 60 kGy; and
a neck opening,
wherein the fabric of the body includes an extension at the neck opening to form a mask for covering the mouth and nose, and
wherein the mask is made from the same fabric as the body.

34. The nonwoven web laminate of claim 1 wherein:
the gamma sterilizable nonwoven material comprises an about 30 grams per square meter (GSM) polyester nonwoven fabric;
the gamma sterilizable coating material comprises an about 30 GSM polyethylene laminate; and
wherein the nonwoven web laminate and the gamma sterilizable coating material are adhesively bonded together using about 3.5 GSM of adhesive.

35. The nonwoven web laminate of claim 1 wherein:
the gamma sterilizable nonwoven material and the gamma sterilizable coating material are bonded together using thermal means.

36. The nonwoven web laminate of claim 1 wherein:
the gamma sterilizable nonwoven material comprises an about 25 grams per square meter (GSM) polyester nonwoven fabric;
the gamma sterilizable coating material comprises an about 25 GSM polyethylene laminate; and
wherein the nonwoven web laminate and the gamma sterilizable coating material are adhesively bonded together using about 3.5 GSM of adhesive.
